(19) United States
(12) Patent Application Publication
(10) Pub. No.: US 2026/0249543 A1
(43) Pub. Date: Aug. 27, 2026

(54) DIMENSIONALLY STABLE BIODEGRADABLE FILM

(71) Applicant: Danimer IPCo, LLC, Bainbridge, GA (US)

(72) Inventors: Satyabrata Samanta, Lilburn, GA (US); Laura Emery, Kaukauna, WI (US); Jerri DiRenzo, Wilmington, DE (US); Adam Johnson, Bainbridge, GA (US)

(73) Assignee: Danimer IPCo, LLC, Bainbridge, GA (US)

(21) Appl. No.: 18/994,246

(22) PCT Filed: Jul. 28, 2023
(86) PCT No.: PCT/US2023/029022

§ 371 Date: Jan. 14, 2025

Related U.S. Application Data
(60) Provisional application No. 63/369,997, filed on Aug. 1, 2022.

(51) Int. Cl. B29C 55/28; B29C 55/14; B29K 67/00

(52) U.S. Cl. CPC B29C 55/28; B29C 55/143; B29K 2067/04; B29K 2995/0053; B29K 2995/006; B29K 2995/0097

(57) ABSTRACT

A method for improving the dimensional stability of biodegradable films. The method includes providing a poly(hydroxyalkanoate)-based blown polymer film to a nip roller, feeding the poly(hydroxyalkanoate)-based blown polymer film to an annealing roller, and heating the blown film by contact with the annealing roller for a predetermined period of time and at a temperature ranging from about 80 to about 150° C.

### RELATED APPLICATION

This application claims priority to provisional application No. 63/369,997, filed Aug. 1, 2022.

### TECHNICAL FIELD

The disclosure is directed to biodegradable films and in particular to methods for improving the dimensional stability of poly(hydroxyalkanoate)-based polymer films.

### BACKGROUND AND SUMMARY

Blown polymer film is a major processing technique for film manufacturers to convert polymeric films for use food packaging applications. The blown polymeric films are typically used in a bag making and heat-sealing process that is a widely used for flexible packaging. The stability of the blown polymeric films is critical for maintaining product quality and preventing food quality deterioration during storage. The bag-making and heat-sealing processes are generally carried out at high temperatures. Semicrystalline polymer films tend to shrink as they cool down from elevated temperatures. The degree of shrinkage largely depends on the composition of the film materials and the processing conditions used to produce the films. Semicrystalline materials shrink more than amorphous materials. The dimensional instability or shrinkage of the film when cooled from an elevated temperature plays a significant role in the overall quality of the finished product. Significant shrinkage after the bag making or heat-seal process can contribute to some imperfections in the finished product including leakages, risks of pinhole formation, and breakages in the sealing area.

Biodegradable poly(hydroxyalkanoate)-based polymer films also shrink when cooled to room temperature from an elevated temperature. The shrinkage properties of poly(hydroxyalkanoate)-based films create significant issues during the coating, metallization, lamination, printing, bag making, and sealing processes using the films. The conventional blown film process produces a poly(hydroxyalkanoate)-based polymer film with 45% to 50% shrinkage measured in the machine direction (MD) at 110° C. The temperature selected for shrinkage measurements is the temperature used for most of the film's post-processing pieces of equipment. The shrinkage value for the poly(hydroxyalkanoate)-based polymer films is significantly higher compared to the industry standard of less than 5% for other polymer films. Accordingly, what is needed is an improved process for making poly(hydroxyalkanoate)-based polymer films that provides films having a significantly lower shrinkage when used for packaging applications.

In view of the foregoing, an embodiment of the disclosure provides a method for improving the dimensional stability of a machine direction oriented (MDO) biodegradable film. The method includes providing a poly(hydroxyalkanoate)-based blown polymer film to a nip roller, feeding the poly(hydroxyalkanoate)-based blown polymer film to an annealing roller, and heating the blown film by contact with the annealing roller for a predetermined period of time and at a temperature ranging from about 80 to about 150° C.

In one embodiment, the method includes heating the blown film by contact with the annealing roller to a temperature ranging from about 100 to about 120° C.

In one embodiment, the blown film has a thickness ranging from about 7 microns to about 260 microns.

In another embodiment, the predetermined period of time according to the method ranges from about one second to about one minute.

In another embodiment, there is provided a machine direction oriented (MDO) poly(hydroxyalkanoate)-based film made by providing the poly(hydroxyalkanoate)-based blown polymer film to a nip roller, feeding the poly(hydroxyalkanoate)-based blown polymer film to an annealing roller, and heating the blown film by contact with the annealing roller for a predetermined period of time and at a temperature ranging from about 80 to about 150° C.

In another embodiment, there is provided a dimensionally-stable, biodegradable packaging film made by providing a poly(hydroxyalkanoate)-based blown polymer film to a nip roller, feeding the poly(hydroxyalkanoate)-based blown polymer film to an annealing roller, and heating the blown film by contact with the annealing roller for a predetermined period of time and at a temperature ranging from about 80 to about 150° C.

In another embodiment, there is provided a method for improving the dimensional stability of a biodegradable film, comprising providing a poly(hydroxyalkanoate)-based bi-axially oriented polymer film with various machine direction orientation (MDOP) and various transverse-direction orientation (TDO), feeding the bi-axially orientation film to an annealing roller, and heating the bi-axially orientation film by contact with the annealing roller for a predetermined period of time and at a temperature ranging from about 80 to about 150° C.

In another embodiment, the biodegradable film is stretched in the machine direction from about 0.3 to about 10 times.

In another embodiment, the biodegradable film is stretched in the transverse direction from about 0.3 to about 10 times.

As described in more detail below, certain blown film annealing conditions may provide the optimal dimensional stabilities or minimize shrinkage of poly(hydroxyalkanoate)-based films. According to the disclosure, a heat treatment process is applied to relieve the inherent stress created during the blown film extrusion process. If annealed properly, the poly(hydroxyalkanoate)-based film should not change in diameter over time, or when exposed to elevated temperatures. Accordingly, embodiments of the disclosure provide blown film annealing condition which can provide poly(hydroxyalkanoate)-based films with 4% or less shrinkage at high temperatures (100° C.). Dimensionally stable poly(hydroxyalkanoate)-based films made according to the disclosure may be particularly useful for in the food packaging industry.

### DETAILED DESCRIPTION

In one aspect, the present disclosure provides polymeric film compositions which are suitable for, among other things, packaging for consumer goods.

Preferably, the polymeric film compositions are biodegradable and/or compostable. More particularly the polymeric film compositions are both biodegradable and compostable.

As used herein, the term “biodegradable” refers to a plastic or polymeric material that will undergo biodegradation by living organisms (microbes) in anaerobic and aerobic environments (as determined by ASTM D5511), in soil environments (as determined by ASTM 5988), in freshwater environments (as determined by ASTM D5271 (EN 29408)), or in marine environments (as determined by ASTM D6691). The biodegradability of biodegradable plastics can also be determined using ASTM D6868 and European EN 13432.

The polymeric film compositions of the present disclosure are preferably also “compostable,” as determined by ASTM D6400 for industrial or home compostability.

In particular, the biodegradable polymeric film composition includes poly(hydroxyalkanoate) as a first biodegradable polymer. The composition is generally made up of from about 5 weight percent to about 95 weight percent poly(hydroxyalkanoates). More preferably, the composition is made up of from about 35 weight percent to about 90 weight percent poly(hydroxyalkanoates). Still more preferably, the polymeric composition includes from about 40 weight percent to about 70 weight percent poly(hydroxyalkanoates)

In some instances, the poly(hydroxyalkanoates) in the composition are preferably made up of a mixture of a first copolymer and a second copolymer. The first copolymer includes from about 90 to about 99.9 mole percent monomer residues of 3-hydroxybutyrate and from about 0.1 to about 10 mole percent monomer residues of a second 3-hydoxyalkanoate having from 5 to 12 carbon atoms. The second copolymer includes at least 70 mole percent monomer residues of 3-hydroxybutyrate and monomer residues of the second 3-hydoxyalkanoate having from 5 to 12 carbon atoms in amount which at least 6 mole percent less than the amount of the second 3-hydoxyalkanoate in the first polymer.

It has been found that, when the different in the mole percentages of the second 3-hydoxyalkanoate in the first copolymer and the second copolymer is at least 6 mole percent, then the first and second copolymers are no longer miscible with one another, but instead separate into different poly(hydroxyalkanoates) within the composition. This may be used advantageously alter the properties of the final composition.

In such instances, the inclusion of a relatively small amount of the second poly(hydroxyalkanoate) copolymer improves the impact properties or toughness of the composition, providing articles with improved performance.

The polymeric composition also includes a second biodegradable polymer selected from the group consisting of poly(butylene succinate), poly(butylene succinate-co-adipate), poly(lactic acid), cellulose esters (such as cellulose acetate), thermoplastic starch, and mixtures thereof. The amount of this second biodegradable polymer is typically from about 5 weight percent to about 95 weight percent of the total composition.

In some embodiments, the second biodegradable polymer may include poly(butylene succinate) in an amount from about 5 weight percent to about 50 weight percent of the polymeric composition. More preferably, the polymeric composition includes from about 10 weight percent to about 30 weight percent poly(butylene succinate).

According to some embodiments, the second biodegradable polymer may include poly(butylene succinate)-co-butylene adipate in an amount from about 5 weight percent to about 50 weight percent of the polymeric composition. More preferably, the polymeric composition includes from about 10 weight percent to about 30 weight percent poly(butylene succinate)-co-butylene adipate.

In some instances, the second biodegradable polymer may include poly(lactic acid) in an amount from about 10 weight percent to about 70 weight percent of the polymeric composition. More preferably, the polymeric composition includes from about 20 weight percent to about 60 weight percent poly(lactic acid).

In certain embodiments, the second biodegradable polymer may include cellulose acetate or another cellulose ester in an amount from about 5 weight percent to about 50 weight percent of the polymeric composition. More preferably, the polymeric composition includes from about 10 weight percent to about 30 weight percent cellulose acetate or another cellulose ester.

In each of the various compositions discussed above, the poly(hydroxyalkanoate) polymer may be a homopolymer, made up only a single type of monomer residues. Generally, the poly(hydroxyalkanoate) polymer is a copolymer, made up of at least two different types of monomer residues. In some instances, the poly(hydroxyalkanoate) polymer may be a terpolymer, made up of at least three different type of monomer residues.

For instance, in some embodiments, the at least one poly(hydroxyalkanoate) polymer is preferably a copolymer made up of from about 75 to about 99.9 mole percent monomer residues of 3-hydroxybutyrate and from about 0.1 to about 25 mole percent monomer residues of a second 3-hydoxyalkanoate having from 5 to 12 carbon atoms.

In other embodiments, the at least one poly(hydroxyalkanoate) polymer is preferably a terpolymer made up from about 75 to about 99.9 mole percent monomer residues of 3-hydroxybutyrate and from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In general, the at least one poly(hydroxyalkanoate) polymer has a weight average molecular weight from about 50,000 Daltons to about 7.5 million Daltons, and more preferably has a weight average molecular weight from about 300,000 Daltons to about 3.0 million Daltons as determined by ASTM D6474-20.

In certain embodiments, the poly(hydroxyalkanoate) and the at least one biodegradable polymer are preferably reacted with each other in a transesterification. In such instances, a small amount of a catalyst (such as tin ethylhexanoate) may optionally be incorporated into the composition so as to facilitate the transesterification reaction. Transesterification of the poly(hydroxyalkanoate) and the at least one biodegradable polymer leads to, for example, branched structures that provide for better processability with less energy consumption. Transesterification can also provide for improved physical properties, as the transesterified polymers can act as interfacial agents and improve the compatibility of other polymer molecules in the composition that may not have completely reacted.

Most commonly, the aforementioned transesterification reaction is carried out by reacting the poly(hydroxyalkanoate) and the at least one biodegradable polymer with each other in a reactive extrusion process.

A nucleating agent is also typically present in the polymeric composition in an amount from about from about 0.1 weight percent to about 5 weight percent. In certain embodiments, the core layer nucleating agent is preferably selected from the group consisting of erythritols, pentaerythritol, dipentaerythritols, artificial sweeteners, stearates, polysaccharides, sorbitols, mannitols, inositols, polyester waxes, nanoclays, behenamide, erucamide, stearamide, oleamide, polyhydroxybutyrate, thymine, cyanuric acid, cytosine, adenine, uracil, guanine, boron nitride and mixtures thereof.

The polymeric composition may also include an optional plasticizer material as well. Suitable materials for the plasticizer are typically selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol as determined by ASTM D6474-20, poly(ethylene glycols) having a number average molecular weight of 400-10,000 g/mol as determined by ASTM D6474-20, esters of vegetable oils, long chain alkyl acids, adipates, glycerol, isosorbide derivatives or mixtures thereof, polymeric plasticizers, poly(hydroxyalkanoates) copolymers comprising at least 18 mole percent monomer residues of hydroxyalkanoates other than hydroxybutyrate, and mixtures thereof.

The amount of plasticizer in polymeric composition may be up to about 15 weight percent. More preferably, the polymeric composition is made up of from about 5 weight percent to about 15 weight percent of the plasticizer.

Optionally, the polymeric composition may also include a filler material. Suitable materials for the filler are typically selected from the group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, casein, collagen, gelatin, polysaccharides, guar gum, xanthan gum, succinoglycan, natural rubbers; rosinic acid, lignins, natural fibers, jute, kenaf, hemp, ground nut shells, wood flour, and mixtures thereof., and mixtures thereof.

The amount of filler in the polymeric composition may be up to about 50 weight percent. More preferably, the core layer polymeric composition is made up of from about 5 weight percent to about 40 weight percent of the filler.

Further, the polymeric composition may also include up to 20 weight percent of an impact modifier. More preferably, the polymeric composition includes from about 5 weight percent to about 15 weight percent of the impact modifier. Suitable impact modifiers for the polymeric compositions are preferably selected from the group consisting of acrylic-based resins and emulsions, isosorbide derivatives, natural rubbers, aliphatic polyesters, or mixtures thereof.

Moreover, in some instances, the polymeric composition may include up to 50 weight percent of one or more additives selected from the group consisting of poly(vinyl alcohols), poly(vinyl acetate), poly(vinyl laurate), poly(ethylene vinyl acetate), poly(glycolic acid), furandicarboxylic acid-based polyesters, cellulose, nanocellulose, glucans, and mixtures thereof.

In each of the various polymeric compositions discussed above, the poly(hydroxyalkanoate) polymer may be a homopolymer, made up only a single type of monomer residues. Generally, the poly(hydroxyalkanoate) polymer is a copolymer, made up of at least two different type of monomer residues. In some instances, the poly(hydroxyalkanoate) polymer may be a terpolymer, made up of at least three different type of monomer residues.

For instance, in some embodiments, the at least one poly(hydroxyalkanoate) polymer is preferably a copolymer made up of from about 75 to about 99.9 mole percent monomer residues of 3-hydroxybutyrate and from about 0.1 to about 25 mole percent monomer residues of a second 3-hydoxyalkanoate having from 5 to 12 carbon atoms.

In other embodiments, the at least one poly(hydroxyalkanoate) polymer is preferably a terpolymer made up from about 75 to about 99.9 mole percent monomer residues of 3-hydroxybutyrate and from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In general, the at least one poly(hydroxyalkanoate) polymer has a weight average molecular weight from about 50,000 Daltons to about 7.5 million Daltons, and more preferably has a weight average molecular weight from about 300,000 Daltons to about 3.0 million Daltons as determined by ASTM D6474-20.

In a further aspect, the present disclosure also provides a product package for a consumer goods product, which makes use of the aforementioned polymeric composition. Specifically, the product package includes at least one biodegradable package portion which comprises the aforementioned polymeric composition. The product package may be used for the packaging of clothing, household goods, foods, and health and beauty products.

In certain embodiments, this biodegradable package portion may be formed by a method selected from the group consisting of injection molding, compression molding, thermoforming, cast and blown film formation, extrusion coating, extrusion blow molding, injection stretch blow molding, and extrusion profiling.

### Crystallinity

The volume percent crystallinity (Pc) of a semi-crystalline polymer (or copolymer) often determines what type of end-use properties the polymer possesses. For example, highly (greater than 50%) crystalline polyethylene polymers are strong and stiff, and suitable for products such as plastic milk containers. Low crystalline polyethylene, on the other hand, is flexible and tough, and is suitable for products such as food wraps and garbage bags. Crystallinity can be determined in a number of ways, including x-ray diffraction, differential scanning calorimetry (DSC), density measurements, and infrared absorption. The most suitable method depends upon the material being tested.

The volume percent crystallinity (Φc) of the poly(hydroxyalkanoate) copolymer may vary depending on the mol percentage of poly(3-hydroxyhexanoate) in the poly(hydroxyalkanoate) copolymer. The addition of poly(3-hydroxyhexanoate) effectively lowers the volume percent crystallinity of the poly(hydroxyalkanoate) copolymer, crystallization rate, and melting temperature while providing an increase in the flexibility and degradability of the copolymer. Nucleating agents, as described herein may be used to speed up the crystallization process of the poly(hydroxyalkanoate) copolymers.

In general, poly(hydroxyalkanoates) of the present invention preferably have a crystallinity of from about 0.1% to about 99% as measured via x-ray diffraction; more preferably from about 2% to about 80%; more preferably still from about 20% to about 70%.

When a poly(hydroxyalkanoates) of the present invention is to be processed into a molded article or film, the amount of crystallinity in such poly(hydroxyalkanoate) is more preferably from about 10% to about 80% as measured via x-ray diffraction; more preferably from about 20% to about 70%; more preferably still from about 30% to about 60%.

### Melt Temperature

Preferably, the biodegradable poly(hydroxyalkanoates) of the present invention have a melt temperature (Tₘ) of from about 30° C. to about 170° C., more preferably from about 90° C. to about 165° C., more preferably still from about 130° C. to about 160° C.

### Method of Film Manufacture

The films of the present invention used as container labels having increased biodegradability and/or compostability may be processed using conventional procedures for producing single or multilayer films on conventional film-making equipment. Pellets of the poly(hydroxyalkanoates) of the present invention may be dry blended and then melt mixed in a film extruder. Alternatively, if insufficient mixing occurs in the film extruder, the pellets may be dry blended and then melt mixed in a pre-compounding extruder followed by repelletization prior to film extrusion.

The poly(hydroxyalkanoates) of the present invention can be melt processed into films using either cast or blown film extrusion methods both of which are described in PLASTICS EXTRUSION TECHNOLOGY—2nd Ed., by Allan A. Griff (Van Nostrand Reinhold-1976). In a cast film process, the molten polymer mixture is extruded through a linear slot die. Generally, the flat web is cooled on a large moving polished metal roll. The web quickly cools and peels off this first roll, passes over one or more auxiliary cooling rolls, then through a set of rubber-coated pull or “haul-off” rolls, and finally to a winder.

In a blown film extrusion process, the molten polymer formulation is extruded upward through a thin annular die opening. The blown film process is also referred to as tubular film extrusion. Air is introduced through the center of the die to inflate the tube causing it to expand. A moving bubble is thus formed which is held at a constant size by control of internal air pressure. The tube of film is cooled by air, blown through one or more chill rings surrounding the tube. The tube is then collapsed by drawing it into a flattening frame through a pair of pull rolls and into a winder. For label applications the flattened tubular film is subsequently slit open, unfolded, and further slit into widths appropriate for use as labels.

Both cast film and blown film processes may be used to produce either monolayer or multilayer film structures. For the production of monolayer films from a single thermoplastic material or blend of thermoplastic components only a single extruder and single manifold die are required.

For the production of multilayer films, coextrusion processes are preferably employed. Such processes require more than one extruder and either a coextrusion feed-block or multi-manifold die system or combination of the two to achieve the multilayer film structure.

It has been discovered, quite surprisingly, that the annealing temperatures of annealing rollers during a blown film and cast film production process may control or minimize shrinkage of poly(hydroxyalkanoate)-based polymer films. The improved annealing process of a poly(hydroxyalkanoate)-based polymer film may be achieved by heating the film above its glass transition temperature and below its melting temperatures for a period of time and then allowing the film to cool back down to room temperature so the material can relax. It is believed that annealing the semi-crystalline film material at a relatively a higher temperature can improve quality of the film in terms of micro and macro-structural features such as crystalline morphology, density, grain size etc. Accordingly, the improved annealing process can provide film dimensional stability and/or minimize shrinkage by relieving internal stresses within the film material. The overall shrinkage improvement depends on the annealing temperature and the annealing time.

The following non-limiting example illustrates a process to control shrinkage of poly(hydroxyalkanoate)-based polymeric films having machine direction orientation (MDO) for blown film process and both machine direction orientation (MDO) and transverse direction orientation (TDO) for a biaxially-oriented process.

### Example 1

Formulated poly(hydroxyalkanoate)-based polymeric materials were converted into barrier and print film by using a conventional blown film process that was stretched in the machine direction three times (MDO). Experiments were carried out with various annealing roller temperatures with the same extruder and MDO profile. Film samples were prepared with the annealing roller temperature at 60° C., 80° C., 100° C., 110° C. and 120° C. Both machine direction (MD) and transverse direction (TD) shrinkage was investigated at 45° C., 80° C., 100° C. and 110° C. using the method described in ASTM D2732. The films annealing temperatures and shrinkage data at 45° C., 80° C., 100° C. and 110° C. are shown in Table 1. The shrinkage measurement temperatures were selected based on a storage temperature of 45° C. for finished products storage and shipping and post processing temperatures, such as coating, metallization and sealing temperatures (80° C., 100° C. and 110° C.).

TABLE 1

| Annealing | Shrinkage | | | |
|---|---|---|---|---|
| Roller | Measurement | Time in | MD | TD |
| Temperature | Temperature | oil bath | Shrinkage | Shrinkage |
| (° C.) | (° C.) | (sec) | (%) | (%) |
| 60 | 45 | 30 | 4 | 0 |
| 60 | 80 | 30 | 33 | −1.3 |
| 60 | 100 | 30 | 43 | −1.7 |
| 60 | 110 | 30 | 49.3 | −2 |
| 80 | 45 | 30 | 2 | 0 |
| 80 | 80 | 30 | 26.7 | −3.7 |
| 80 | 100 | 30 | 37.7 | −4.2 |
| 80 | 110 | 30 | 44.8 | −4.5 |
| 100 | 45 | 30 | 1.7 | 0 |
| 100 | 80 | 30 | 14.7 | −3 |
| 100 | 100 | 30 | 25.7 | −4.2 |
| 100 | 110 | 30 | 32.7 | −5 |
| 110 | 45 | 30 | 0.8 | 0 |
| 110 | 80 | 30 | 6.7 | −1 |
| 110 | 100 | 30 | 13 | −2.3 |
| 110 | 110 | 30 | 18 | −2.7 |
| 120 | 45 | 30 | 0 | 0 |
| 120 | 80 | 30 | 1.8 | −0.2 |
| 120 | 100 | 30 | 4 | −1 |
| 120 | 110 | 30 | 6 | −1 |

As shown in the above table, the poly(hydroxyalkanoate) film shrinkage values with lower annealing temperature (60° C.) were very high compared to the industry standard of less than 5%. The shrinkage values significantly decreased with annealing temperatures above 100° C. and reached the industrial standard values of less than 5% with an annealing temperature of 120° C.

The following non-limiting example illustrates a process to control shrinkage of poly(hydroxyalkanoate)-based polymeric films made by a biaxially-oriented film process.

### Example 2

Samples poly(hydroxyalkanoate)-based films were prepared using various transverse-direction orientation (TDO) annealing temperature using the same extruder and MDO profile. The transverse direction (TD) annealing temperatures that were used were 60° C., 93° C., and 129° C. The shrinkage measurement temperatures were selected based on the maximum temperature expected for finished products storage/shipping (45° C.) and post processing process; like coating, metallization, and sealing temperatures (80° C., 100° C. and 110° C.). Both machine direction (MD) and transverse direction (TD) shrinkage were investigated by heating the finished film in a 110° C. oven for 10 minutes. ISO 14616 was used to determine the shrinkage values. The results are provided in the following table.

TABLE 2

| | Oven | | | |
|---|---|---|---|---|
| Annealing | Shrinkage | Oven | MD | TD |
| Temperature | Temperature | Time | Shrinkage | Shrinkage |
| (° C.) | (° C.) | (minutes) | (%) | (%) |
| 60 | 110 | 10 | 14 | 39 |
| 93 | 110 | 10 | 6 | 22 |
| 129 | 110 | 10 | 0 | 0 |

The poly(hydroxyalkanoate) film shrinkage values at the lower annealing temperature (60° C.) were very high compared to the industry standard of less than 5%. The shrinkage values were significantly decreased with higher annealing temperatures and reached the industrial standard values of less than 5% with an annealing temperature of 129° C.

Poly(hydroxyalkanoate)-based polymeric films were made by modifying poly(hydroxyalkanoates) with melt strength enhancers, chain extenders, and other processing aids. The poly(hydroxyalkanoate)-based films made according to the disclosure may contain from about 50 to 80 weight percent of poly(hydroxyalkanoate) copolymer and from about 20 to about 50 wt. % polymer modifiers. In some embodiments, the poly(hydroxyalkanoate) copolymer is poly-3-hydroxybutyrate-co-3-hydroxyhexanoate.

Exemplary formulations that may be used to make biodegradable films according to the disclosure are shown in the following table.

TABLE 3

| | poly(hydroxyalkanoate) | poly(hydroxyalkanoate) | | | | | Weight % |
|---|---|---|---|---|---|---|---|
| | polymer wt. % | polymer wt. % | Weight % | Weight % | | | Poly(butylene |
| | 6 mol % Hexanoate | 2 mol % Hexanoate | Polylactic | Polyethylene | Weight % | Weight % | succinate- |
| Formula | in polymer | in polymer | acid | Glycol | CaCO₃ | Pentaerythritol | adipate) |
| 1 | 60 | 0 | 36 | 3 | 0 | 1 | 0 |
| 2 | 60 | 0 | 39 | 0 | 0 | 1 | 0 |
| 3 | 0 | 60 | 36 | 3 | 0 | 1 | 0 |
| 4 | 50 | 0 | 25 | 5 | 19 | 1 | 0 |
| 5 | 70 | 0 | 19 | 0 | 0 | 1 | 10 |
| 6 | 70 | 0 | 16 | 3 | 0 | 1 | 10 |

Poly(hydroxyalkanoate) films have been formulated to be run on both cast and blown film lines, both with and without orientation. The poly(hydroxyalkanoate) films offer excellent barrier for use in packaging applications and high Dyne levels giving excellent printability for use in labels. Several formulations have been tested in making poly(hydroxyalkanoate) films, and these formulations may be changed and optimized for individual applications and equipment.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for improving the dimensional stability of a biodegradable film, comprising providing a poly(hydroxyalkanoate)-based blown polymer film to a nip roller, feeding the poly(hydroxyalkanoate)-based blown polymer film to an annealing roller, and heating the blown film by contact with the annealing roller for a predetermined period of time ranging from about 1 second to about one minute and at a temperature ranging from about 80 to about 150° C.

2. The method of claim 1, wherein the blown film is heated to a temperature ranging from about 100 to about 120° C.

3. The method of claim 1, wherein the blown film has a thickness ranging from about 7 microns to about 250 microns.

4. (canceled)

5. The method of claim 1, wherein the poly(hydroxyalkanoate)-based blown polymer film was stretched in the machine direction from about 0.3 times to about 10 times.

6. The method of claim 1, wherein the poly(hydroxyalkanoate)-based blown polymer film was stretched in the transverse direction from about 0.3 times to about 10 times.

7. A poly(hydroxyalkanoate)-based film made by the method of claim 1.

8. A dimensionally-stable, biodegradable packaging film comprising the poly(hydroxyalkanoate)-based film of claim 7.

9. A method for improving the dimensional stability of a biodegradable film, comprising providing a poly(hydroxyalkanoate)-based bi-axially oriented polymer film with various machine direction orientation (MDO) and various transverse-direction orientation (TDO), feeding the bi-axially orientation film to an annealing roller, and heating the bi-axially orientation film by contact with the annealing roller for a predetermined period of time ranging from about 1 second to about 1 minute and at a temperature ranging from about 80 to about 150° C.

10. The method of claim 9, wherein the bi-axially oriented polymer film is heated to a temperature ranging from about 100 to about 120° C.

11. The method of claim 9, wherein the bi-axially oriented polymer film has a thickness ranging from about 7 microns to about 250 microns.

12. (canceled)

13. A bi-axially oriented poly(hydroxyalkanoate)-based film made by the method of claim 9.

14. A dimensionally-stable, biodegradable packaging film comprising the bi-axially oriented poly(hydroxyalkanoate)-based film of claim 13.
